(19) United States
(12) Patent Application Publication
(10) Pub. No.: US 2022/0147005 A1
(43) Pub. Date: May 12, 2022

(54) COMBINATORICS OF DIGITAL OUTPUT DATA FOR AUTONOMOUS DETERMINATION OF PROCESS CYCLES AND OF INDIVIDUAL PROCESS STEPS

(71) Applicant: PHOENIX CONTACT GMBH & CO. KG, Blomberg (DE)

(72) Inventor: Guido Mertens, Blomberg (DE)

(21) Appl. No.: 17/441,686

(22) PCT Filed: Feb. 20, 2020
(86) PCT No.: PCT/EP2020/054515

§ 371 Date: Sep. 21, 2021

(30) Foreign Application Priority Data
Mar. 25, 2019 (DE) 10 2019 107 576.9

(51) Int. Cl. G05B 19/045

(52) U.S. Cl. CPC G05B 19/045; G05B 2219/23289

(57) ABSTRACT

An apparatus is provided for automatically determining process steps of a control device. The apparatus includes a measuring device, which is configured to detect a plurality of sequences of switching states of a plurality of input and output signals of the control device and an evaluation device, which is configured to determine combinatorics in the detected plurality of sequences of switching states of the plurality of input and output signals of the control device and to determine the process steps performed by the control device based on the determined combinatorics.

### CROSS-REFERENCE TO RELATED APPLICATIONS

This application is the US national phase application of PCT/EP2020/054515, filed Feb. 20, 2020, which claims priority to German Patent Application No. DE 10 2019 107 576.9, filed Mar. 25, 2019, each of which is hereby incorporated by reference in its entirety.

### FIELD

The present invention relates to systems for combinatorics of digital output data for autonomous determination of process cycles and for automatic identification of individual process steps.

In particular, the present invention relates to an apparatus and a method for automatic determination of process steps of a control unit or control device.

### BACKGROUND

Energy data acquisition is a common means of determining the energy consumption of production plants or even only production plant-installed components, for example of a technical production plant.

The goal is often to conclude the consumption of individual parts of the technical production plant with as few measuring means as possible, and even to determine anomalies of individual electrical power or energy consumers by deviations of the momentary consumption values from target values or empirical values.

Here the methods, especially the mathematics, are very complex and the methods based on them are often not generally applicable to any real technical problems.

### SUMMARY

It is an object of the present invention to provide an improved apparatus and method for automatically determining process steps of a control device.

This task or object is solved by the subject matter of the appended independent patent claims. Further embodiments and embodiments can be found in the dependent patent claims, the description and the figures of the drawings of the present patent application.

A first aspect of the present invention relates to a device or an apparatus for automatically determining process steps of a control unit or control device. The apparatus comprises a measuring device and an evaluation device.

The measuring device is adapted to detect a plurality of sequences of switching states of a plurality of input and output signals of the control device.

The evaluation device is configured to determine combinatorics in the detected plurality of sequences of switching states of the plurality of input and output signals of the control device and to determine the process steps performed by the control device based on the determined combinatorics.

In automation technology, it is common to control individual consumers and actuators via digital outputs. These outputs can be tapped and analyzed independently of the control program.

Each process step will have a different data conversion and/or transformation of the input data to the output data. Consequently, each different data conversion and transformation indicates the use and execution of different process steps.

For example, if the sequences of process steps repeat, the present invention can advantageously thereby also identify the cycle of the automation solution, such as when corresponding, detectable data transformations and data transformations also show up in the output data or switching states and are identified and detected by the evaluation device.

This can be done independently of programming and without the intervention of an expert in the automation solution by means of an automated query. The method underlying the present invention can therefore be retrofitted independently of the application and without any special knowledge of the automation task.

With this method, in combination with energy data, one gets a clear picture of the energy consumption of the individual process steps and can draw better conclusions about the energy consumption values of the consumers involved in the individual process step and determine corresponding consumption data.

Due to the automatic identification of the process steps and the automatic identification of the process cycles, when retrofitting a measuring system described here, the operator receives a proposal after the setup phase for the process cycles carried out by the control device and the corresponding process phases, which can be individually designated on the basis of the successful automated identification.

Deviations in the process can thus be traced back and identified precisely to process steps and consumers involved, and can also be displayed. This enables condition- and/or operation-dependent maintenance and also predictive maintenance.

The present invention makes it possible to determine combinatorics of digital input and/or output data for autonomous determination of process cycles and of individual process steps of a control device in order to analyze and minimize an energy consumption of a production plant controlled by the control device.

Further advantageous exemplary embodiments of the present invention are to be taken from the dependent claims.

In an advantageous exemplary embodiment of the present invention, it is provided that the evaluation device is configured to determine at least one process cycle based on the determined combinatorics, wherein the at least one process cycle comprises a plurality of the process steps performed by the control device.

Advantageously, this also enables predictions to be provided about the entire automation solution as used by the control device.

In an advantageous exemplary embodiment of the present invention, it is provided that the input and output signals of the control device comprise switching states of inputs and outputs of the control device. This advantageously enables switching states to be taken into account.

In an advantageous exemplary embodiment of the present invention, it is provided that the apparatus is further adapted to be coupled to digital and/or analog inputs and outputs of the control unit or control device. Advantageously, this enables subsequent retrofitting of control units or devices already in use.

In an advantageous exemplary embodiment of the present invention, it is provided that the evaluation device is configured to compare at least one sequence of the detected plurality of sequences of switching states of the plurality of input and output signals of the control device with input or output data sequences stored in a database device, wherein each stored input or output data sequence can be assigned to a predetermined process step of the control device.

In an advantageous exemplary embodiment of the present invention, it is provided that the evaluation device is configured to compare the determined combinatorics with a plurality of input or output data combinatorics stored in a database device, wherein each stored input or output data corn binatorics can be assigned to a predetermined process step of the control device. This advantageously enables a stored plurality of already determined process cycles and associated switching states to be compared with currently detected sequences of switching states of a plurality of input and output signals of the control device.

In an advantageous exemplary embodiment of the present invention, it is provided that the evaluation device is configured to determine an automation solution of the control device on the basis of the determined combinatorics.

In an advantageous exemplary embodiment of the present invention, it is provided that the evaluation device is configured to determine a total energy consumption of electrical loads coupled to the control device on the basis of the detected plurality of sequences of the switching states of the plurality of input and output signals of the control device.

In an advantageous exemplary embodiment of the present invention, it is provided that the evaluation device is configured to determine the total energy consumption of electrical loads coupled to the control device on the basis of individual energy consumption values of the electrical loads coupled to the control device and on the basis of operating intervals of the electrical loads, wherein the evaluation device is further configured to determine the operating intervals of the electrical loads from the sequences of the switching states of the plurality of input and output signals of the control device.

In an advantageous exemplary embodiment of the present invention, it is provided that the evaluation device is configured to store the process steps determined and performed by the control device and to transmit the stored process steps to the control device in the event of a software update of the control device.

In an advantageous exemplary embodiment of the present invention, it is provided that the apparatus is configured to generate an automatically generated designation or identification for the process steps based on the stored process steps.

In an advantageous exemplary embodiment of the present invention, it is provided that the apparatus further comprises a display device which is adapted to display the automatically generated designation for the process steps; and/or wherein the device is further adapted to transmit the automatically generated designation for the process steps to the control device.

According to a further, second aspect of the present invention, a method is provided for automatically determining process steps of a control device, the method comprising the following method steps:

As a first method step, a detection of a plurality of sequences of switching states of a plurality of input and output signals of the control device is performed by means of a measuring device.

As a second method step, combinatorics are determined in the detected plurality of sequences of the switching states of the plurality of input and output signals of the control device by means of an evaluation device.

As a third method step, a determination of the process steps performed by the control device is performed based on the determined combinatorics by means of the evaluation device.

According to a further, third aspect, the present invention comprises a computer program or computer program product comprising instructions that, when the program is executed by a computer, cause the computer to execute the steps of the method according to the second aspect or any embodiment of the second aspect.

According to a further, fourth aspect, the present invention comprises a computer-readable storage medium comprising instructions that, when executed by a computer, cause the computer to execute the steps of the method according to the second aspect or any embodiment of the second aspect.

The described embodiments and further embodiments may be combined with each other as intended.

Other possible embodiments, further embodiments and implementations of the present invention also include combinations of features of the present invention described previously or hereinafter with respect to the embodiments that are not explicitly mentioned.

The accompanying drawings are intended to provide a further understanding of embodiments of the present invention.

The accompanying drawings illustrate embodiments and, in connection with the description, serve to explain concepts of the present invention.

Other embodiments and many of the advantages mentioned will be apparent with reference to the figures of the drawings. The elements shown in the figures of the drawings are not necessarily shown to scale with respect to each other.

### BRIEF DESCRIPTION OF THE DRAWINGS

FIG. 1 is a schematic representation of a device for automatically determining process steps of a control unit or device according to an exemplary embodiment of the present invention.

FIG. 2 is a schematic diagram of a flowchart of a method for automatically determining process steps of a control unit or device according to an exemplary embodiment of the present invention.

FIG. 3 is a schematic representation of a hardware structure according to an exemplary embodiment of the present invention.

FIG. 4 is a schematic representation from a web-based user interface according to an exemplary embodiment or example of the present invention.

### DETAILED DESCRIPTION

In the figures of the drawings, identical reference signs denote identical or functionally identical elements, parts, components or process steps, unless otherwise indicated.

For example, the term “combinatorics” as used by the present invention refers to finite or countably infinite discrete structures within the sensed sequences of switching states. In other words, one or more sequences of switching states are repeated according to a pattern, i.e., a process of repeating the same or similar process steps multiple times.

The term “switching state” as used by the present invention refers, for example, to the operating principle of a switch, that is, an actuation of a switch results, for example, in a switching state open or closed.

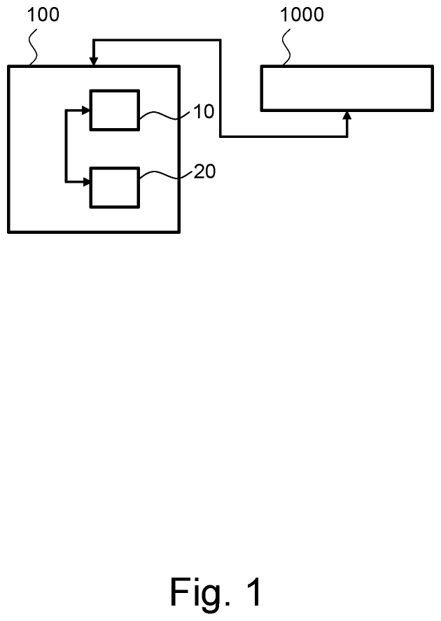

FIG. 1 shows a schematic diagram of a device or apparatus for automatically determining process steps of a control device according to an exemplary embodiment of the present invention.

The device or apparatus 100 comprises a measuring device 10 and an evaluation device 20. The device 100 can be coupled to a control unit or control device 1000.

The measuring device 10 is configured to detect a plurality of sequences of switching states of a plurality of input and output signals of the control device 1000.

The evaluation device 20 is configured to determine a combinationality in the detected plurality of sequences of switching states of the plurality of input and output signals of the control device 1000.

Further, the evaluation device 20 is adapted to determine, based on the determined combinatorics, the process steps performed by the control device 1000

The present method enables to provide an automatic identification and analysis of the process steps and/or process cycles performed by a control device.

The measuring device 10 is configured, for example, as a measuring device for detecting an input or output signal.

The analysis device 20 is configured, for example, to perform an assignment of digital representative data to the process steps and/or process cycles performed by a control device 1000.

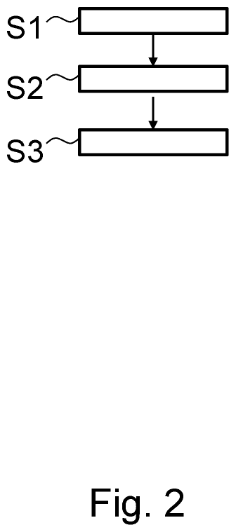

FIG. 2 shows a schematic diagram of a flow chart of a method for automatically determining process steps of a control unit or device according to an exemplary embodiment of the present invention.

As a first method step, a detection S1 of a plurality of sequences of switching states of a plurality of input and output signals of the control unit or device is performed by means of a measuring device 10.

As a second method step, a determination S2 of combinatorics in the detected plurality of sequences of switching states of the plurality of input and output signals of the control device is performed by means of an evaluation device.

As a further, third method step, a determination S3 of the process steps performed by the control device is carried out based on the determined combinatorics by means of the evaluation device 20.

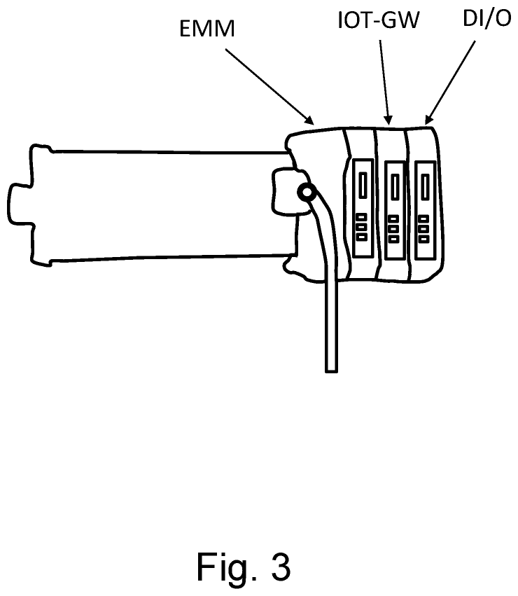

FIG. 3 shows a schematic diagram of a hardware structure according to an exemplary embodiment of the present invention.

The hardware setup shown in FIG. 3 represents a setup of a control device coupled to a device according to the present invention.

An energy measuring device EMM is coupled to a cloud gateway IOT-GW and digital input module DI/O for evaluating output signals of a controller or a control device.

The cloud gateway has an interface to the Internet and communication interfaces to common bus systems to communicate also with a control system.

This is necessary because not all consumers are controlled via physical 24V outputs, but also directly via a BUS system and thus virtual I/O data. All data is transferred to a cloud and can be evaluated independently of the automation solution.

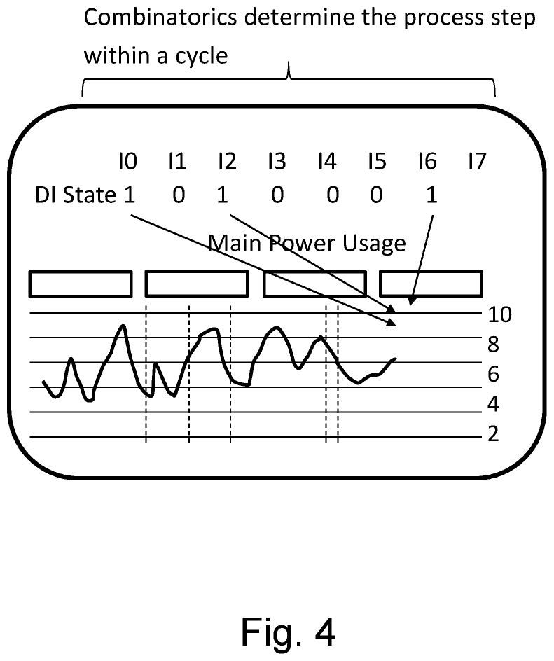

FIG. 4 shows a schematic representation of a web-based user interface according to an exemplary embodiment of the present invention.

In the visualization of the cloud data, cycle time and individual process phases are automatically determined, and can be individually designated by the operator. In this example, a process cycle with eight process steps is shown. The individual steps have been designated differently and different consumers are involved in each case.

A repetition of the sequence of the individual process steps allows the length of the entire cycle to be estimated.

For example, according to an embodiment example of the present invention, the method of the present invention generates a proposal for an identified process cycle and the operator defines therefrom the beginning and the end of the process cycle controlled by the control unit or device, designates the individual process steps of the process cycle, and assigns the respective consumers to the individual outputs of the control unit or device.

According to an embodiment of the present invention, the output circuit of a switching device is detected as shown in FIG. 4:

For example, a designation of the process steps is defined as follows:

1000 end
0100 start

For example, the following illustrated sequence of switching states of a plurality of input and output signals of the control device may be detected as follows.

1000 end
0100 start
0110
0111
1000 end
0100 start
0110
0111
1000 end

Here the operator can define the combination 0100 as start and the combination 1000 as end. The process shown has only four individual steps.

The associated energy consumption, Main power usage, is also shown in FIG. 4.

The present invention enables products and solutions for predictive maintenance. Production equipment does not have to fail before it is repaired. The present invention enables intelligent systems to detect a failure before it occurs. The present invention enables energy-efficient production to be developed.

An ambitious sub-objective is to disaggregate or break down individual loads solely from analysis of total energy consumption of mixed loads.

Although the present invention has been described above with reference to preferred embodiments, it is not limited thereto, but can be modified in a variety of ways. In particular, the invention can be changed or modified in a variety of ways without departing from the essence of the invention.

Further, it should be noted that “comprising” and “comprising” do not exclude other elements or steps, and “one” or “a” do not exclude a plurality.

It should further be noted that features or steps that have been described with reference to any of the above exemplary embodiments may also be used in combination with other features or steps of other exemplary embodiments described above. Reference signs in the claims are not to be regarded as a limitation.

1. An apparatus for automatically detecting process steps of a control device, the apparatus comprising:
a measuring device which is configured to detect a plurality of sequences of switching states of a plurality of input and output signals of the control device; and
an evaluation device, which is configured to determine combinatorics in the detected plurality of sequences of switching states of the plurality of input and output signals of the control device and to determine the process steps performed by the control device based on the determined combinatorics.

2. The apparatus according to claim 1, wherein the evaluation device is configured to determine at least one process cycle based on the determined combinatorics, wherein the at least one process cycle comprises a plurality of the process steps performed by the control device.

3. The apparatus according to claim 1, wherein the input and output signals of the control device comprise switching states of inputs and outputs of the control device.

4. The apparatus according to claim 1, wherein the device is further adapted to be coupled to digital and/or analog inputs and outputs of the control device.

5. The apparatus according to claim 1, wherein the evaluation device is configured to compare at least one sequence of the detected plurality of sequences of the switching states of the plurality of input and output signals of the control device with input or output data sequences stored in a database device, wherein each stored input or output data sequence can be assigned to a predetermined process step of the control device.

6. The apparatus according to any of the preceding claim 1, wherein the evaluation device is designed to compare the determined combinatorics with a plurality of input or output data combinatorics stored in a database device, wherein each stored input or output data combinatorics can be assigned to a predetermined process step of the control device.

7. The apparatus according to claim 1, wherein the evaluation device is configured to determine an automation solution of the control device on the basis of the determined combinatorics.

8. The apparatus according to claim 1, wherein the evaluation device is configured to determine a total energy consumption of electrical loads coupled to the control device on the basis of the detected plurality of sequences of the switching states of the plurality of input and output signals of the control device.

9. The apparatus according to claim 8, wherein the evaluation device is configured to determine the total energy consumption of electrical consumers coupled to the control device on the basis of individual energy consumption values of the electrical consumers coupled to the control device and on the basis of operating intervals of the electrical consumers, wherein the evaluation device is further designed to determine the operating intervals of the electrical consumers from the sequences of the switching states of the plurality of input and output signals of the control device.

10. The apparatus according to claim 1, wherein the evaluation device is configured to store the process steps determined and performed by the control device and, in the event of a software update of the control device, to transmit the stored process steps to the control device.

11. The apparatus according to claim 10, wherein the device is configured to generate an automatically generated designation for the process steps based on the stored process steps.

12. The apparatus according to claim 10, wherein the apparatus further comprises a display device which is configured to display the automatically generated designation for the process steps; and/or wherein the apparatus is further adapted to transmit the automatically generated designation for the process steps to the control device.

13. A method of automatically detecting process steps of a control device, the method comprising the steps of:
detecting a plurality of sequences of switching states of a plurality of input and output signals of the control device by measuring device and determining combinatorics in the detected plurality of sequences of switching states of the plurality of input and output signals of the control device by an evaluation device;
determining the process steps performed by the control device based on the determined combinatorics by the evaluation device.

14. The method according to claim 13, wherein the method is further comprising:
determining at least one process cycle performed by the control device based on the determined combinatorics, wherein the at least one process cycle comprises a plurality of the process steps performed by the control device.
